(19) United States
(12) Patent Application Publication
(10) Pub. No.: US 2011/0214965 A1
(43) Pub. Date: Sep. 8, 2011

(54) MEDICAL GUIDE LEAFLET INSERTION DEVICE

(76) Inventor: Kenneth G. Murphy, Mount Laurel, NJ (US)

(21) Appl. No.: 12/719,804

(22) Filed: Mar. 8, 2010

(51) Int. Cl. B65G 47/84

(52) U.S. Cl. 198/479.1

(57) ABSTRACT

A vertical device and method for the ultimate insertion of a leaflet or the like together with a container such as a medical bottle into a carton and which can be used in conjunction with either a vertical or a horizontal cartoner.

### CROSS REFERENCE TO RELATED APPLICATIONS

Applicant claims priority from Provisional Application Ser. No. 60/158,302 filed Mar. 6, 2009.

### FEDERALLY SPONSORED RESEARCH AND/OR DEVELOPMENT

Not applicable.

### BACKGROUND OF THE INVENTION

In the pharmaceutical field, it is often necessary when packaging to include a detailed leaflet with the bottle or other container bearing the medical product, both of which are then placed in a carton. Past designs utilized to insert leaflets into cartons were generally vacuum “pick n′ place” type devices which inserted leaflets into cartons along side of containers carried by cartoner buckets. Examples of such “pick n′ place” devices can be found in U.S. Pat. Nos. 4,350,466 and 4,696,715, and the references cited therein. However, these devices could not readily place the leaflet in a vertical attitude in the bucket and the cartoner had to insert the container and leaflet into the carton after the container and leaflet were properly inserted into the conveyor bucket. The typical bucket design has two cleats, one for a container and one for a leaflet. The two need to be present to be inserted in the cartoner or the conveyor sensors will automatically blow off the container with a missing leaflet or the leaflet with a missing container.

### BRIEF STATEMENT OF THE INVENTION

This invention provides a high-speed device and method for the vertical joining of a leaflet or the like into side-by-side association with a container, such as a medical bottle, for their ultimate joint delivery to and insertion into a carton. The device and method can be adapted for use with either a vertical or a horizontal cartoner.

### BRIEF DESCRIPTION OF THE DRAWINGS

FIG. 1 illustrates the leaflet feeding mechanism in conjunction with a vacuum-free star wheel;

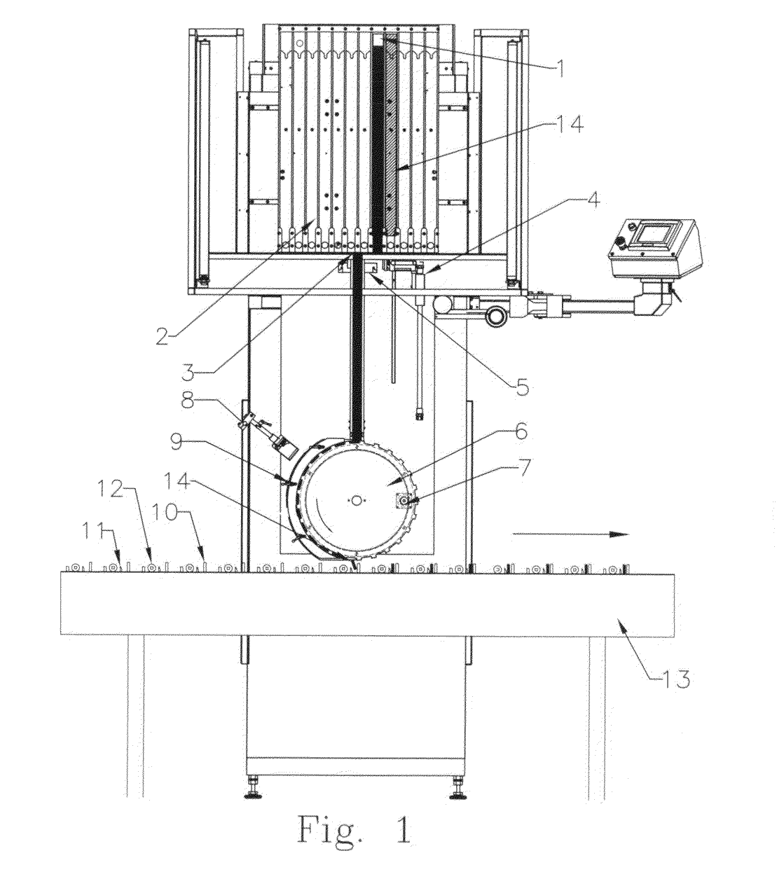

FIG. 2 illustrates in detail the upper section of the leaflet feeder of FIG. 1;

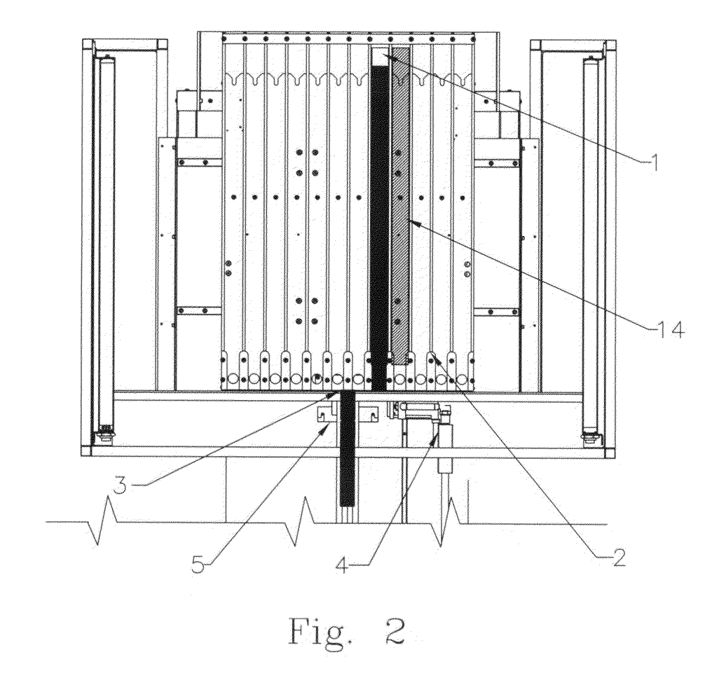

FIG. 3 illustrates in detail the lower section of the leaflet feeder of FIG. 1;

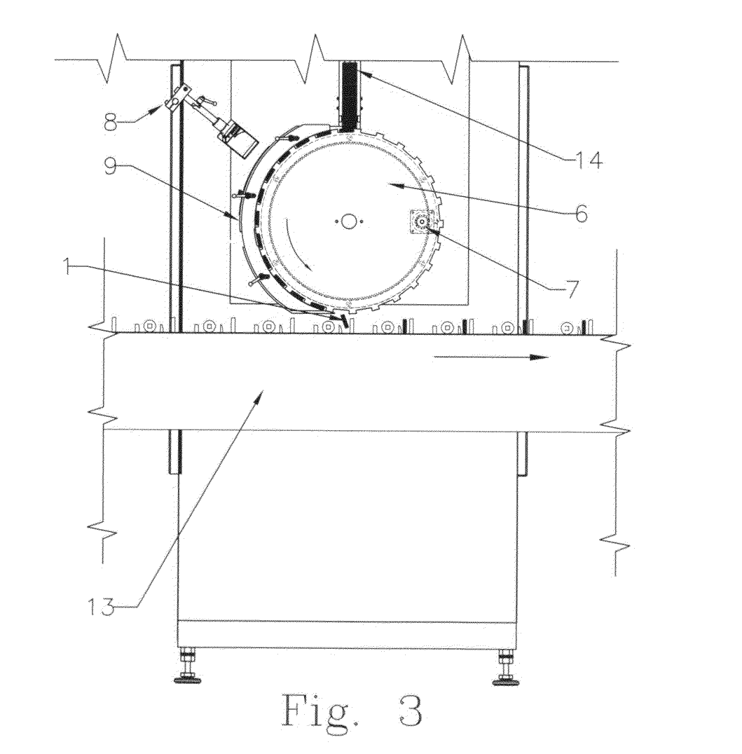

FIG. 4 is a blow-up of the star wheel as shown in FIG. 1 at the point (16) of its operational junction with cleated conveyer (13);

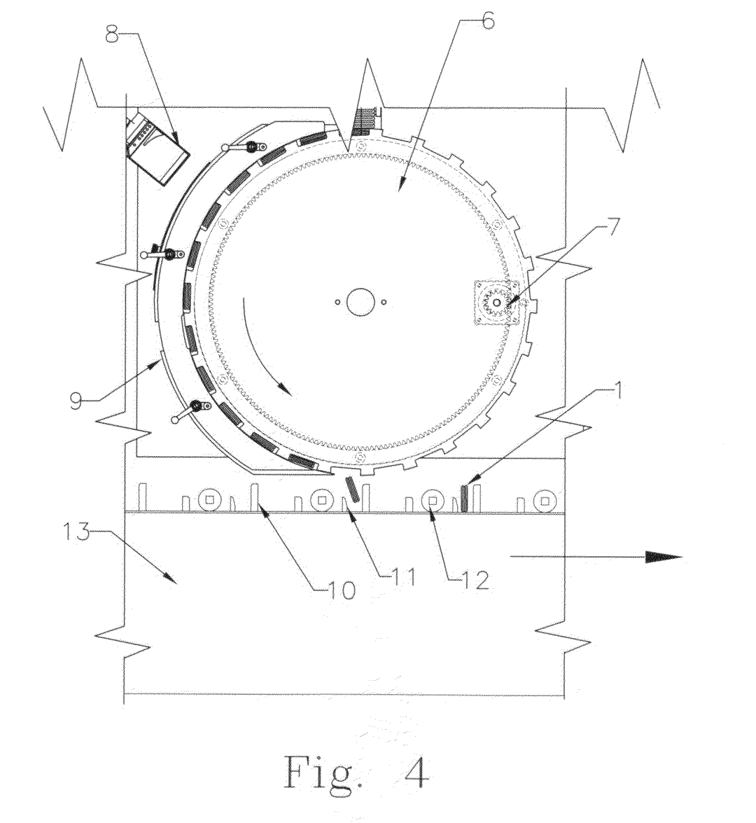

FIG. 5 is a front view of an assembly line including the leaflet feeding mechanism with vacuum-free star wheel, as adapted for use with a horizontal cartoner;

FIG. 6 is a top view of the assembly line of FIG. 5.

### DETAILED DESCRIPTION OF THE INVENTION

The purpose of this invention is to place medical guide leaflets (14) vertically into a cleated conveyor (13) that is utilized, in conjunction with a cartoner, without the necessity of utilizing a vacuum for that purpose, and thereby permitting greatly increased packing speed. The leaflet (14) is placed next to a container (12) and the leaflet (14) and container (12) are then pushed into a carton at the discharge end of the cleated conveyor. This unique device can insert large, thick leaflets at a high rate of speed into a cleated conveyor utilizing a non-vacuum star wheel (6) that has pockets to fit the leaflets. The large diameter star (6) is servo driven with a motor (7) that drives the outer ring gear (17) and is electronically synchronized to the conveyor (13) velocity.

The leaflets (14) are loaded into the machine's leaflet feeder (15) via cardboard boxes (1). The cardboard boxes (1) are pre-packed with leaflets (14). An operator opens the perforated end of the boxes (1) and loads the boxes into a multiposition feeder (15) (shown as a 12 position feeder in the drawings). Lane carriage (2) is one of such carriages which accept cardboard supply cartons containing the paper leaflets. An operator loads each lane with the full cartons. The carriage can index either right to left or left to right and aligns each lane with item feeder throat (5). When a sensor senses a carton in any particular lane the carriage stops and aligns with leaflet feeder throat (5). Once aligned the paper leaflets drop out of the carton and feed by gravity into feeder throat (5).

Once loaded, the machine's feeder will open a gate (3) and the leaflets (14) are dropped onto a lowering device (4), referred to hereinafter as a “lowerator”. The lowerator (4) lowers the leaflets (14) toward the star wheel (6) to ensure consistent backlog into the star. The dropping leaflets are guided into the star wheel by changeable guide (9) which helps align them on the conveyer (13). The non-vacuum star wheel (6) extracts one leaflet (14) at a time. The large diameter star (6) rotates and allows the leaflets (1) to be scanned via barcode scanner (8) to ensure the correct leaflets (14) is positioned at the application point (16) in the vertical attitude. The outer guide (9) holds the leaflet (14) in the star wheel. The leaflet is guided around the star and is dispensed at the bottom of the star placing the leaflet into a passing conveyor (13). By accelerating the trailing edge of the leaflet (14) with the star wheel (6), the leaflet (14) will be positioned into the cleated conveyor (13) in the correct vertical attitude. The cleat (10) is used as a backstop for the leaflet (14) and the leaflet (14) is positioned vertical between the cleat (10) and the smaller cleat (11).

Cartoners, or cartoner machines, typically are designed to insert a material or substance, or a package of material or substance, into a carton. For example, the cartoner machine may be configured to open or unfold a carton, insert the material or package into the carton and thereafter close the carton. Cartoners generally are designed to fill and close a large number of cartons in a relatively short period of time, and are typically incorporated into an assembly line. As such, it is important to minimize the amount of time required to fill and close the carton, while at the same time minimizing the number of malfunctions, including, for example, jamming, breaking or otherwise damaging the package and/or carton, which can lead to downtime of the machine. Typically, cartoners are configured as vertical cartoners or horizontal cartoners. Detailed information with regard to specific, available cartoners can be found in U.S. Pat. Nos. 5,551,217 and 6,725,629 and the references cited therein.

Vertical cartoners typically insert a material or package of material vertically into a carton having an upwardly facing open end. In this way, gravity assists in the insertion and/or filling process. Typically, the cartons are intermittently conveyed or moved beneath a filling station, at which the carton is filled.

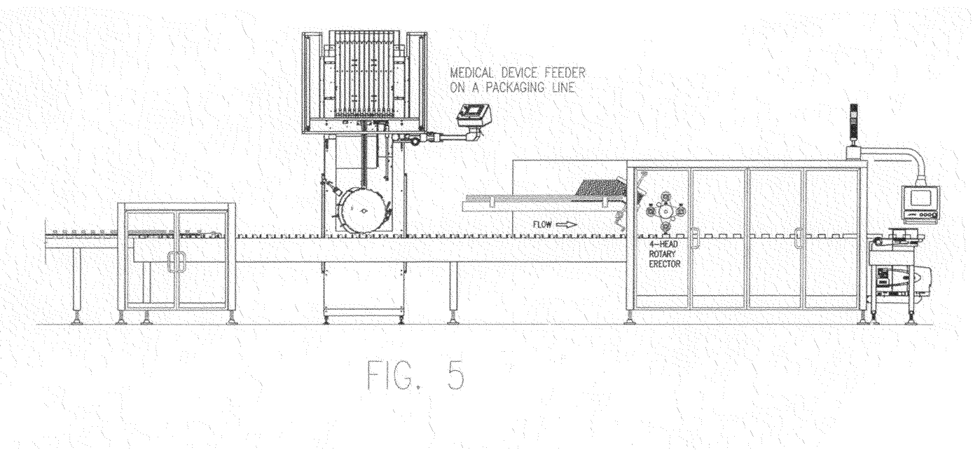

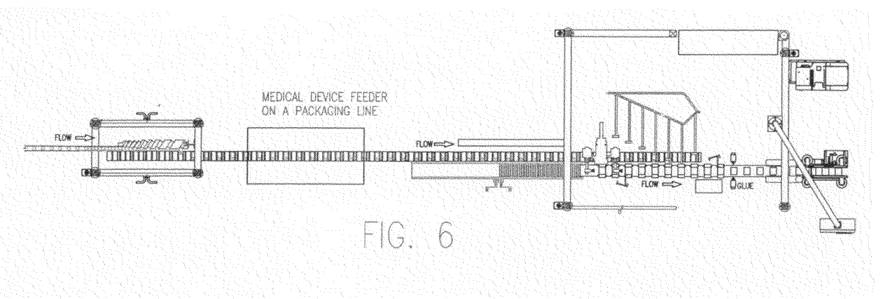

Horizontal cartoners typically insert a package of material horizontally into a carton, which typically is configured with an open end that faces sideways. Often, horizontal cartoners include a series of trays, which are shaped to hold the package (usually on three sides), and a series of push members, which gradually push the package horizontally from the tray into a carton as the tray and push members move together along the assembly line. Often, when the packages hold a fluid substance, such as a liquid or powder, the packages can be difficult to insert into the carton. Moreover, the speed of the overall process line is often limited by the rate at which the cartons are filled. In addition, when a malfunction, such as a jam, occurs at any one of the tray/pusher stations, the entire line may need to be shut down, thereby decreasing the overall efficiency of the system. FIGS. 5 and 6 show a typical relationship between the conveyer and a horizontal cartoner. The cartoner is provided with pushers which push the pharmaceutical container and the related leaflet into a carton. For the purposes of the present invention, each pusher is slotted to permit each individual pusher to push both a container and a leaflet simultaneously without contacting the smaller cleat (11) that separates them on the conveyer (13).

What is claimed is:

1. A vertical leaflet delivery device adapted to be used in conjunction with a cleated conveyor having pockets for the carriage and delivery of both a container and an informational leaflet to a carton, the improvement which comprises:
a leaflet feeder comprising a plurality of vertical lanes adapted to receive leaflets and to deliver such leaflets to a feeder throat;
a gated feeder throat adapted to receive leaflets from said leaflet feeder and to align them with their ultimate delivery point on the cleated conveyor and to deliver them to a lowerator when the gated throat is opened;
a lowerator adapted to receive leaflets from said gated feeder throat and to deliver them to a non-vacuum star wheel; and
a non-vacuum star wheel adapted to receive leaflets one at a time and to deliver each such leaflet to a separate pocket of a cleated conveyor.

2. The method for delivery of leaflets to a cartoner comprising the use of the vertical leaflet delivery device of claim 1.
